(19) United States
(12) Patent Application Publication
(10) Pub. No.: US 2016/0330251 A1
(43) Pub. Date: Nov. 10, 2016

(54) METHOD AND DEVICE FOR SHARING CONNECTION INFORMATION IN ELECTRONIC DEVICE

(71) Applicant: SAMSUNG ELECTRONICS CO., LTD., Suwon-si Gyeonggi-do (KR)

(72) Inventors: Jong-Myung LEE, Suwon-si, Gyeonggi-do (KR); Byung-Hyun AHN, Seoul (KR)

(21) Appl. No.: 15/105,357

(22) PCT Filed: Dec. 2, 2014
(86) PCT No.: PCT/KR2014/011685

§ 371 Date: Jun. 16, 2016

(30) Foreign Application Priority Data
Dec. 18, 2013 (KR) 10-2013-0157769

(51) Int. Cl. H04L 29/06; G09B 5/12

(52) U.S. Cl. CPC H04L 65/1069; H04L 65/403; G09B 5/125

(57) ABSTRACT

According to various embodiments, a method includes: establishing, by a first electronic device, communication with at least one electronic device associated with a first application and located outside the electronic device; identifying, by the first electronic device, at least one second electronic device to execute at least one second application associated with the first application from among the at least one electronic device based on the first application; and transmitting, by the first electronic device, a content related to the at least one second application to the at least one second electronic device. Various embodiments are possible.

### BACKGROUND ART

Various embodiments of the present disclosure relate to a method and apparatus for sharing connection information in an electronic device.

Electronic devices are able to provide a variety of digital information, for example, photos, videos, music, documents, maps, games, messages, etc., to users through various applications. An electronic device is able to exchange such digital information with a server or other electronic devices through a communication interface.

In general, an electronic device may deliver a variety of digital information to other electronic devices using different applications related to the digital information.

### DETAILED DESCRIPTION OF THE INVENTION

### Technical Problem

Thanks to current technology, an education system using a network can support to provide an interactive education even if an educator and an educatee are not in a fixed place. For example, education information may be delivered among a plurality of electronic devices included in the education system through an application related to the education system. For example, information other than the education information may be delivered through an application corresponding to the corresponding information. Accordingly, there is a problem n that, in order for attendees of the education system to exchange education-related information with one another, applications for processing the corresponding information should establish separate network connection and should use separate resources and a data structure to establish the network connection.

Various embodiments of the present disclosure provide an apparatus and method for enabling an electronic device and other electronic devices included in an education system to exchange education-related information with one another without having to establish a communication link.

Various embodiments of the present disclosure provide an apparatus and method for easily utilizing a new application in an existing education solution and thus enhancing user's convenience.

According to embodiments of the present disclosure, a method may include: establishing, by a first electronic device, communication with at least one electronic device associated with a first application and located outside the first electronic device; identifying, by the first electronic device, at least one second electronic device to execute at least one second application associated with the first application from among the at least one electronic device based on the first application; and transmitting, by the first electronic device, a content related to the at least one second application to the at least one second electronic device.

According to embodiments of the present disclosure, a method may include: receiving, by a second electronic device from a first electronic device, a content to execute one application from among at least one application associated with communication established with the first electronic device using the established communication; searching an application to execute the received content from among the at least one application; and executing the searched application and reproducing the received content.

According to embodiments of the present disclosure, a first electronic device may include a processor which establishes communication with at least one electronic device associated with a first application and located outside the electronic device, and identifies at least one second electronic device to execute at least one second application associated with the first application from among the at least one electronic device based on the first application; and a communication module which transmits a content related to the at least one second application to the at least one second electronic device.

According to embodiments of the present disclosure, a second electronic device may include: a communication module which receives, from a first electronic device, a content to execute one application from among at least one application associated with communication established with the first electronic device using the established communication; and a processor which searches an application to execute the received content from among the at least one application, and executes the searched application and reproduces the received content.

### BRIEF DESCRIPTION OF THE DRAWINGS

FIG. 1 illustrates a block diagram of an electronic device according to one embodiment of the present disclosure;

FIG. 2 illustrates a block diagram of hardware according to one embodiment of the present disclosure;

FIG. 3 illustrates a block diagram of a programming module according to one embodiment of the present disclosure;

FIG. 4 schematically illustrates an information providing system according to one embodiment of the present disclosure;

FIG. 5 illustrates a case in which various functions are set by a group activity according to one embodiment of the present disclosure;

FIGS. 6(a), 6(b) and 6(c) illustrate one embodiment of an application interworking with an education solution according to one embodiment of the present disclosure;

FIG. 7 is a flowchart showing an operation of a first electronic device according to one embodiment of the present disclosure;

FIG. 8 is a flowchart showing an operation of a second electronic device according to one embodiment of the present disclosure;

FIG. 9 is a flowchart showing an operation of a first electronic device according to one embodiment of the present disclosure; and

FIG. 10 is a flowchart showing an operation of a second electronic device according to one embodiment of the present disclosure.

### MODE FOR CARRYING OUT THE INVENTION

Various embodiments of the present disclosure will be described herein below with reference to the accompanying drawings. However, although specific embodiments of the present disclosure are illustrated in the drawings and described in the detailed descriptions, various changes can be made and various embodiments can be provided. This is not to limit the present disclosure to the specific embodiments and should be construed as including all modification, equivalent or alternative included in the idea and the technical scope of the present disclosure. In the explanation of the drawings, similar reference numerals are used for similar elements.

An electronic device according to various embodiments of the present disclosure may be a device including a communication function. For example, the electronic device may be one of various devices or a combination of one or more of various devices, such as a smartphone, a tablet personal computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical machine, an electronic bracelet, an electronic necklace, an electronic appcessory, a camera, a wearable device, an electronic clock, a wrist watch, a smart white appliance (for example, a refrigerator, an air conditioner, a cleaner, an artificial intelligence robot, a television, a Digital Video Disk (DVD) player, a stereo, an oven, a microwave oven, a washing machine, an air cleaner, an electronic album, etc.), various medical machines (for example, Magnetic Resonance Angiography (MRA), Magnetic Resonance Imaging (MRI), Computerized Tomography (CT), a tomograph, an ultrasound machine, and the like), a navigation device, a Global Positioning System (GPS) receiver, an Event Data Recorder (EDR), a Flight Data Recorder (FDR), a set-top box, a TV box (for example, Samsung HomeSync™ Apple TV™, or Google TV™), an electronic dictionary, an automotive infotainment device, electronic equipment for ship (for example, a navigation equipment for ship, a gyro compass, and the like), avionics, a security device, electronic clothing, an electronic key, a camcorder, a game console, a Head-Mounted Display (HIVID), a flat panel display device, an electronic album, a part of furniture or a building/a structure including a communication function, an electronic board, an electronic signature receiving device, a projector, etc. It is obvious that the electronic device according to the present disclosure is not limited to the above-stated devices.

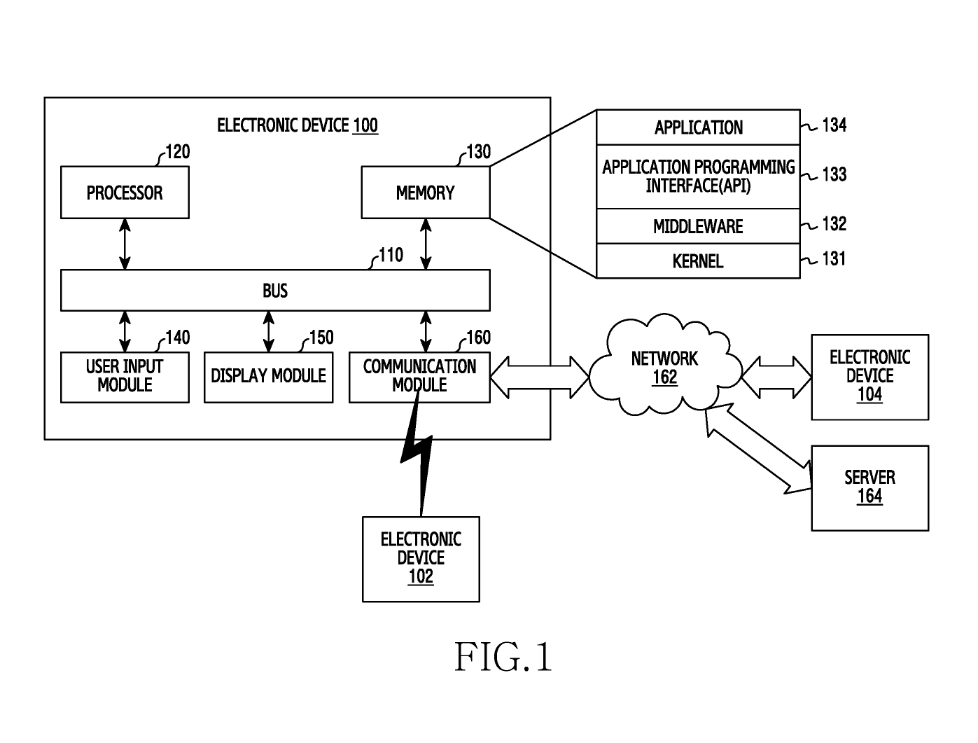

FIG. 1 is a block diagram of an electronic device 100 according one embodiment of the present disclosure. Referring to FIG. 1, the electronic device 100 may include a bus 110, a processor 120, a memory 130, a user input module 140, a display module 150, or a communication module interface 160.

The bus 110 may be a circuit which connects the above-described elements with one another and transmits communication (for example, a control message) between the above-described elements.

The processor 120 may receive instructions from the other elements (for example, the memory 130, the user input module 140, the display module 150, the communication module 160, and the like) via the bus 110, decipher the instructions, and perform calculation or data processing according to the deciphered instructions.

The memory 130 may store instructions or data which is received from or generated by the processor 120 or the other elements (for example, the user input module 140, the display module 150, the communication module 160, and the like). For example, the memory 130 may include programming modules such as a kernel 131, middleware 132, an Application Programming Interface (API) 133, an application 134, and the like. Each of the above-described programming modules may be configured by software, firmware, hardware, or a combination of two or more of them.

The kernel 131 may control or manage system resources (for example, the bus 110, the processor 120, the memory 130, and the like) which are used for performing operations or functions implemented in the other programming modules, for example, the middleware 132, the API 133, or the application 134. In addition, the kernel 131 may provide an interface for allowing the middleware 132, the API 133, or the application 134 to access an individual element of the electronic device 100 and control or manage the element.

The middleware 132 may serve as an intermediary to allow the API 133 or the application 134 to communicate with the kernel 131 and exchange data with the kernel 131. In addition, the middleware 132 may perform load balancing with respect to work requests received from the application(s) 134, for example, by giving priority to use the system resources of the electronic device 100 (for example, the bus 110, the processor 120, the memory 130, and the like) to at least one of the application(s) 134.

The API 133 is an interface for allowing the application 134 to control a function provided by the kernel 131 or the middleware 134, and, for example, may include at least one interface or function for controlling a file, controlling a window, processing an image, or controlling a text.

For example, the user input module 140 may receive instructions or data from a user and transmit the instructions or data to the processor 120 or the memory 130 via the bus 110. The display module 150 may display an image, a video, or data for the user.

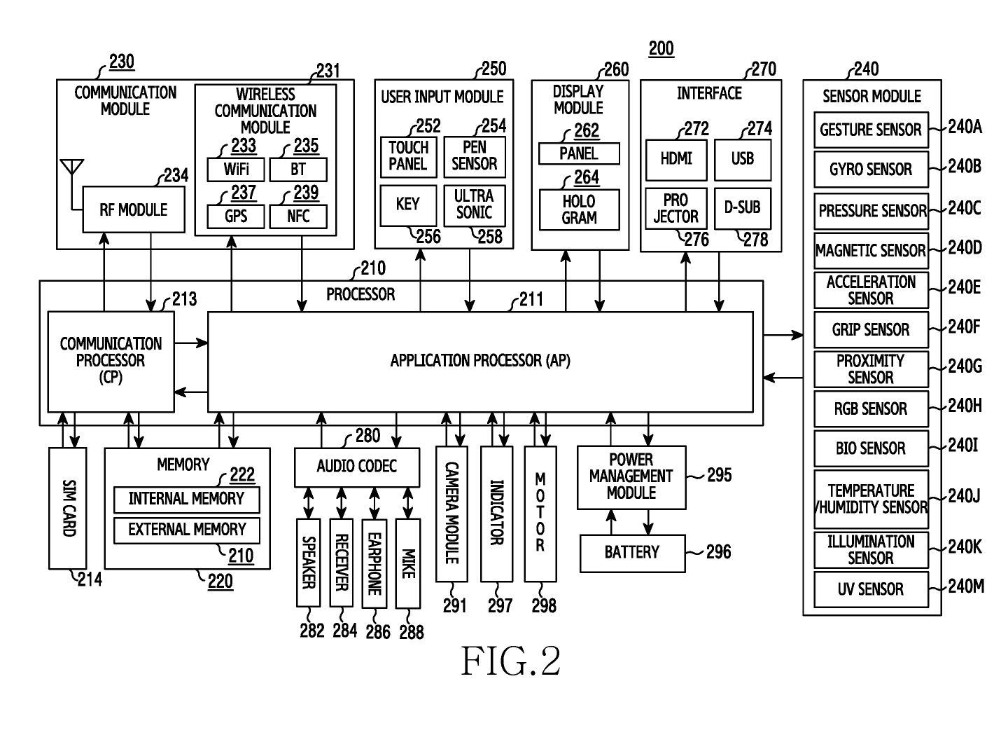

The communication module 160 may establish communication between the electronic device 100 and another electronic device 102. The communication module 160 may support a predetermined short-distance communication protocol (for example, Wireless Fidelity (WiFi), Bluetooth (BT), Near Field Communication (NFC) or predetermined network communication 162 (for example, Internet, a Local Area Network (LAN), a Wire Area Network (WAN), a telecommunication network, a cellular network, a satellite network, or a Plain Old Telephone Service (POTS), etc.). Each of other electronic devices 102, 104 may be the same device as the electronic device 100 (for example, the same type of device) or a different device (for example, a different type of device). FIG. 2 is a block diagram of hardware 200 according to one embodiment of the present disclosure. For example, the hardware 200 may include an entirety or part of the electronic device 100 shown in FIG. 1. Referring to FIG. 2, the hardware 200 may include one or more processors 210, a Subscriber Identification Module (SIM) card 214, a memory 220, a communication module 230, a sensor module 240, an input module 250, a display module 260, an interface 270, an audio module 280, a camera module 291, a power management module 295, a battery 296, an indicator 297, or a motor 298.

The processor 210 (for example, the processor 120) may include one or more Application Processors (APs) 211 or one or more Communication Processors (CPs) 213. For example, the processor 210 may be the processor 120 shown in FIG. 1. In FIG. 2, the AP 211 and the CP 213 are included in the processor 210, but the AP 211 and the CP 213 may be included in different IC packages. In one embodiment, the AP 211 and the CP 213 may be included in a single IC package. The AP 211 may control a plurality of hardware or software elements connected to the AP 211 by driving an operating system or an application program, and may process and calculate various data including multimedia data. For example, the AP 211 may be implemented by using a System on Chip (SoC). In one embodiment, the processor 210 may further include a Graphic Processing Unit (GPU).

The CP 213 may perform functions of managing a data link in communication between an electronic device (for example, the electronic device 100) including the hardware 200 and other electronic devices connected through a network, and converting a communication protocol. For example, the CP 213 may be implemented by using a SoC. In one embodiment, the CP 213 may perform at least part of the multimedia control function. For example, the CP 213 may distinguish and authenticate a terminal in a communication network using a subscriber identification module (for example, the SIM card 214). In addition, the CP 213 may provide services such as a voice call, a video call, a text message, or packet data, etc. to the user.

In addition, the CP 213 may control data exchange of the communication module 230. In FIG. 2, the elements such as the CP 213, the power management module 295, or the memory 220 are separate from the AP 211. However, in one embodiment, the AP 211 may be implemented to include at least part of the above-described elements (for example, the CP 213).

In one embodiment, the AP 211 or the CP 213 may load instructions or data received from a non-volatile memory connected thereto or at least one of the other elements into a volatile memory, and process the instructions or data. In addition, the AP 211 or the CP 213 may store data received from or generated by at least one of the other elements in the non-volatile memory.

The SIM card 214 may be a card including a subscriber identification module, and may be inserted into a slot formed on a specific location of the electronic device. The SIM card 214 may include unique identification information (for example, an Integrated Circuit Card Identifier (ICCID)) or subscriber information (for example, International Mobile Subscriber Identity (IMSI)).

The memory 220 may include an internal memory 222 or an external memory 224. For example, the memory 220 may be the memory 130 shown in FIG. 1. For example, the internal memory 222 may include at least one of a volatile memory (for example, a Dynamic Random Access Memory (DRAM), a Static Random Access Memory (SRAM), a Synchronous DRAM (SDRAM), and the like) and a non-volatile memory (for example, an One-Time Programmable Read Only Memory (OTPROM), a Programmable Read Only Memory (PROM), an Erasable Programmable Read Only Memory (EPROM), an Electrically Erasable Programmable Read Only Memory (EEPROM), a mask ROM, a flash ROM, a NAND flash memory, a NOR flash memory, and the like). In one embodiment, the internal memory 222 may have a form of a solid state drive (SSD). For example, the external memory 224 may further include Compact Flash (CF), Secure Digital (SD), Micro-secure digital (SD), Mini-SD, extreme-Digital (xD), memory stick, and the like. The hardware 200 may further include a storage device (or a storage medium) such as a hard drive although not shown in the drawing.

The communication module 230 may include a wireless communication module 231 or an RF module 234. For example, the communication module 230 may be the communication module 160 shown in FIG. 1. For example, the wireless communication module 231 may include WiFi 233, BT 235, GPS 237, or NFC 239. For example, the wireless communication module 231 may provide a wireless communication function using a radio frequency. Additionally or alternatively, the wireless communication module 231 may include a network interface (for example, a LAN card) or a modem to connect the hardware 200 to a network (for example, Internet, a Local Area Network (LAN), a Wire Area Network (WAN), a telecommunication network, a cellular network, a satellite network or a Plain Old Telephone Service (POTS), etc.). The RF module 234 may transmit and receive data, for example, may transmit and receive an RF signal or a called electronic signal. Although not shown, the RF module 234 may include a transceiver, a Power Amp Module (PAM), a frequency filter, or a Low Noise Amplifier (LNA), for example. In addition, the RF module 234 may further include a part for exchanging electromagnetic waves in a free space in wireless communication, for example, a conductor or conducting wire.

The sensor module 240 may measure a physical quantity or detect an operation state of the electronic device, and may convert measured or detected information into electric signals. The sensor module 240 may include at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (for example, Red, Green, Blue (RGB) sensor), a biosensor 2401, a temperature/humidity sensor 240J, an illuminance sensor 240K, and a Ultraviolet (UV) sensor 240M. Additionally or alternatively, the sensor module 240 may include an E-nose sensor (not shown), an electromyography (EMG) sensor (not shown), an electroencephalogram (EEG) sensor (not shown), an electrocardiogram (ECG) sensor (not shown), an infrared ray (IR) sensor, an iris sensor (not shown), or a fingerprint sensor (not shown), and the like. The sensor module 240 may further include a control circuit to control at least one sensor included therein.

The user input module 250 may include a touch panel 252, a (digital) pen sensor 254, a key 256, or an ultrasonic input device 258. For example, the user input module 250 may be the user input module 140 shown in FIG. 1. The touch panel 252 may recognize a touch input using at least one method of capacitive, resistive, infrared, and ultrasonic methods. In addition, the touch panel 252 may further include a controller (not shown). The capacitive method may recognize physical contact or hovering. The touch panel 252 may further include a tactile layer. In this case, the touch panel 252 may provide a tactile response to the user.

For example, the (digital) pen sensor 254 may be implemented in the same or similar method as or to the method of receiving a user's touch input or by using a separate recognition sheet. For example, the key 256 may include a physical button, an optical key, a keypad, or a touch key. The ultrasonic input device 258 is a device which allows the electronic device to detect sound waves through a microphone (for example, the microphone 288) through an input tool generating ultrasonic signals and identify data, and is capable of wireless recognition. In one embodiment, the hardware 200 may receive a user input from an external device connected thereto (for example, a network, a computer, or a server) using the communication module 230.

The display module 260 may include a panel 262 or a hologram 264. For example, the display module 260 may be the display module 150 shown in FIG. 1. The panel 262 may be a Liquid Crystal Display (LCD) or an Active Matrix Organic Light Emitting Diode (AM-OLED). For example, the panel 262 may be implemented to be flexible, transparent, or wearable. The panel 262 may be configured as a single module along with the touch panel 252. The hologram 264 may show a stereoscopic image in the air using interference of light. In one embodiment, the display module 260 may further include a control circuit to control the panel 262 or the hologram 264.

The interface 270 may include a High Definition Multimedia Interface (HDMI) 272, a Universal Serial Bus (USB) 274, a projector 276, or D-subminiature (sub) 278. Additionally or alternatively, the interface 270 may include Secure Digital (SD)/Multimedia Card (MIVIC) or Infrared Data Association (IrDA) (not shown).

The audio module 280 may convert a sound and an electric signal bidirectionally. For example, the audio module 280 may process sound information which is input or output through a speaker 282, a receiver 284, an earphone 286, or a microphone 288. The camera module 291 is a device for photographing a still image and a moving image, and, in one embodiment, the camera module 291 may include one or more image sensors (for example, a front surface sensor or a rear surface sensor), a lens (not shown), an Image Signal Processor (ISP) (not shown), or a flash (for example, a Light Emitting Diode (LED) or a xenon lamp) (not shown). The power management module 295 may manage power of the hardware 200. Although not shown, the power management module 295 may include a Power Management Integrated Circuit (PMIC), a charger IC, or a battery gage.

For example, the PMIC may be mounted in an integrated circuit or a SoC semiconductor. The charging method may be divided into a wired charging method and a wireless charging method. The charging IC may charge a battery and may prevent inflow of overvoltage or over current from a charger. In one embodiment, the charging IC may include a charging IC for at least one of the wired charging method or the wireless charging method. The wireless charging method may include a magnetic resonance method, a magnetic induction method, or an electromagnetic wave method, and an additional circuit for charging wirelessly, for example, a circuit such as a coil loop, a resonant circuit, a rectifier, and the like may be added.

For example, the battery gage may measure a remaining battery life of the battery 296, a voltage, a current, or temperature during charging. The battery 296 may store or generate electricity and may supply power to the hardware 200 using stored or generated electricity. The battery 296 may include a rechargeable battery or a solar battery. The indicator 297 may display a specific state of the hardware 200 or a part of it (for example, the AP 211), for example, a booting state, a message state, or a charging state. The motor 298 may convert an electric signal into a mechanical vibration. Although not shown, the hardware 200 may include a processing device (for example, a GPU) for supporting a mobile TV. The processing device for supporting the mobile TV may process media data according to standards such as Digital Multimedia Broadcasting (DMB), Digital Video Broadcasting (DVB), or media flow.

The names of the above-described elements of the hardware according to the present disclosure may vary according to a kind of electronic device. The hardware according to the present disclosure may include at least one of the above-described elements, and some of the elements may be omitted or an additional element may be further included. In addition, some of the elements of the hardware according to the present disclosure may be combined into a single entity, and may perform the same functions as those of the elements before being combined.

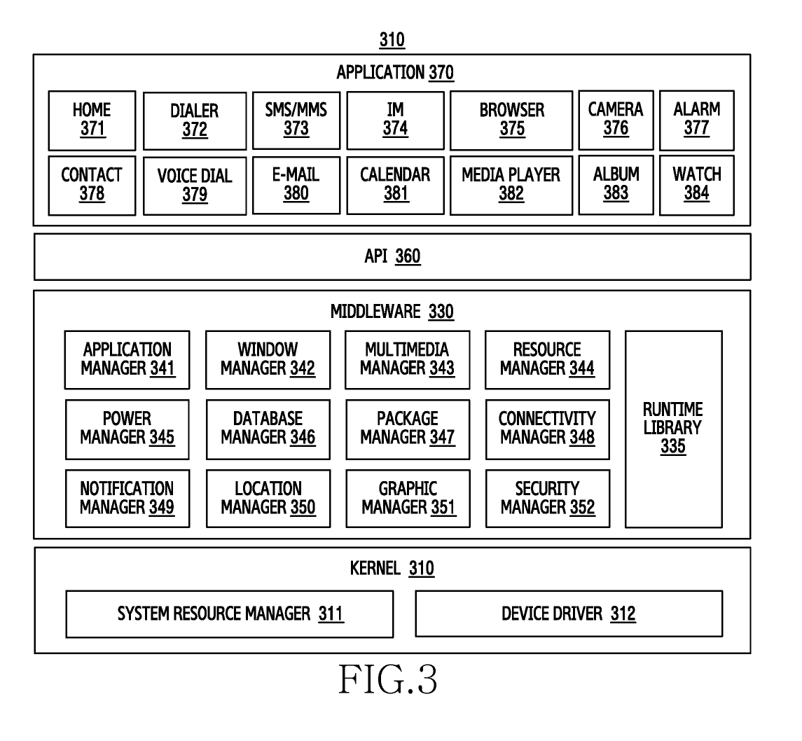

FIG. 3 is a block diagram of a programming module according to one embodiment of the present disclosure. The programming module 300 may be included (for example, stored) in the electronic device 100 (for example, the memory 130) shown in FIG. 1. At least part of the programming module 300 may be configured by software, firmware, hardware, or a combination of two or more of them. The programming module 300 may be implemented in hardware (for example, the hardware 200), and may include an Operating System (OS) for controlling resources related to an electronic device (for example, the electronic device 100) or various applications (for example, the application 370) driven on the OS. For example, the OS may be Android, iOS, Windows, Symbian, Tizen, Bada, or the like. Referring to FIG. 3, the programming module 300 may include a kernel 310, middleware 330, an Application Programming Interface (API) 360, or an application 370.

The kernel 310 (for example, the kernel 131) may include a system resource manager 311 or a device driver 312. For example, the system resource manager 311 may include a process manager 313, a memory manager 315, a file system manager 317, and the like. The system resource manager 311 may control, allocate or collect the system resources. For example, the device driver 312 may include a display driver 314, a camera driver 316, a Bluetooth driver 318, a shared memory driver 320, a Universal Serial Bus (USB) driver 322, a keypad driver 324, a WiFi driver 326, or an audio driver 328. In addition, in one embodiment, the device driver 312 may include an inter-process communication (IPC) (not shown).

The middleware 330 may include a plurality of modules which are implemented in advance to provide a function commonly necessary for the application 370. In addition, the middleware 330 may provide functions to the application 370 through the API 360 such that the application 370 can effectively use limited system resources in the electronic device. For example, as shown in FIG. 3, the middleware 330 (for example, the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

For example, the runtime library 335 may include a library module which is used by a compiler to add a new function through a programming language while the application 370 is executed. In one embodiment, the runtime library 335 may perform functions on input/output management, memory management, an arithmetic function, and the like.

The application manager 341 may manage a life cycle of at least one of the applications 370, for example. The window manager 342 may manage GUI resources used in a screen. The multimedia manager 343 grasps a format necessary for reproducing various media files and encodes or decodes the media files by using a Codec suited to the corresponding format. The resource manager 344 may manage resources such as a source code, a memory, or a storage space of at least one of the applications 370.

The power manager 345 operates along with a Basic Input/Output System (BIOS) to manage a battery or power and provide power information necessary for operations of the electronic device. The database manager 346 may generate, search, or change a database which is used in at least one of the applications 370. The package manager 347 may manage installing or updating an application which is distributed in the form of a package file.

The connectivity manager 348 may manage wireless connection of WiFi, Bluetooth, and the like. The notification manager 349 may display or notify an event such as a message arrived, an appointment, a notification of proximity in such a manner that the event does not hinder the user. The location manager 350 may manage location information of the electronic device. The graphic manager 350 may manage a graphic effect to be provided to the user or a relevant user interface. The security manager 352 may provide an overall security function necessary for system security or user authentication. In one embodiment, when the electronic device (for example, the electronic device 100) is equipped with a telephony function, the middleware 330 may further include a telephony manager to manage a speech or video telephony function of the electronic device.

The middleware 330 may generate a new middleware module by combining various functions of the above-described internal element modules, and use the new middleware module. The middleware 330 may provide a module which is customized according to a kind of OS to provide a distinct function. In addition, the middleware 330 may dynamically delete some of the existing elements or may add new elements. Accordingly, some of the elements described in the embodiments of the present disclosure may be omitted or other elements may further be included, or the elements may be substituted with elements performing similar functions and having different names.

The API 360 (for example, the API 133) is a set of API programming functions and may be provided as a different configuration according to an OS. For example, in the case of Android or iOS, a single API set may be provided for each platform. In the case of Tizen, two or more API sets may be provided for each platform.

The application 370 (for example, the application 134) may include a preloaded application or a third party application, for example.

At least part of the programming module 300 may implemented by instructions stored in computer-readable storage media. When the instructions are executed by one or more processors (for example, the processor 210), the one or more processors may perform a function corresponding to the instructions. The computer-readable storage medium may be the memory 260, for example. At least part of the programming module 300 may be implemented (for example, executed) by the processor 210. At least part of the programming module 300 may include a module, a program, a routine, sets of instructions, or a process to perform one or more functions, for example.

The names of the elements of the programming module (for example, the programming module 300) according to embodiments of the present disclosure may vary according to a kind of an OS. In addition, the programming module according to the present disclosure may include at least one of the above-described elements, omit some of the elements, or may further include additional other elements.

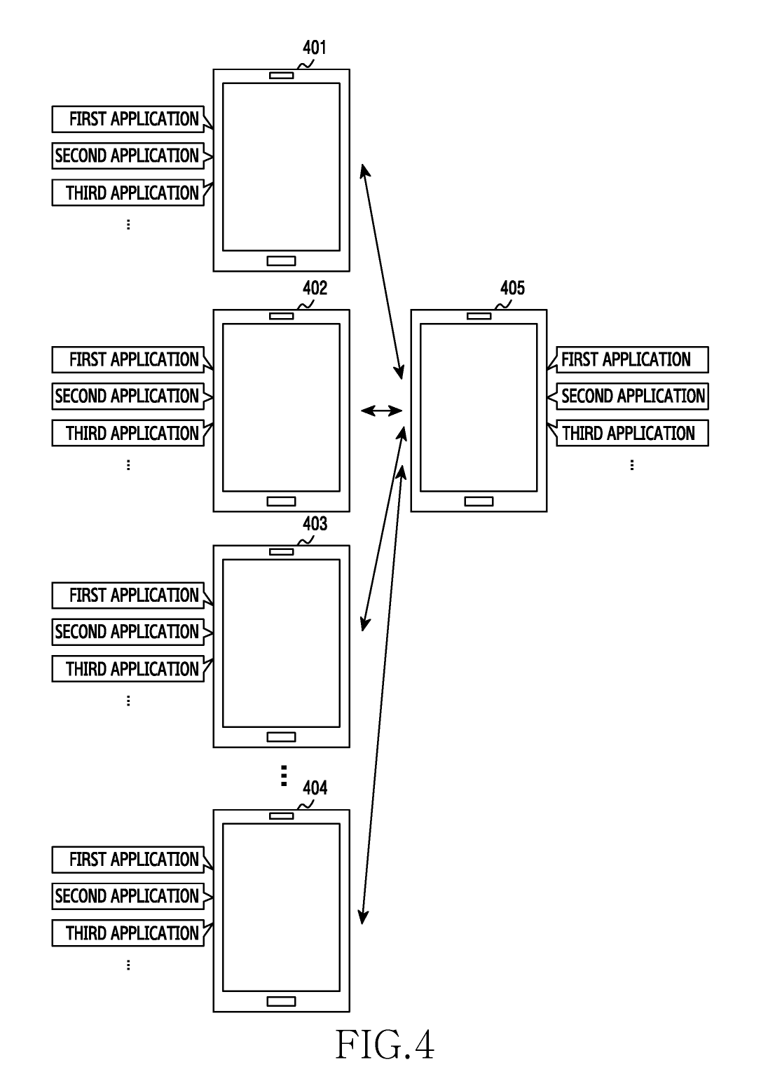

FIG. 4 schematically illustrates an information providing system according to one embodiment of the present disclosure. As shown in FIG. 4, at least one first electronic device 405 may be connected with at least one second electronic device 401, 402, 403, 404 through a network.

For example, the first electronic device 405 may be connected with the second electronic device 401, 402, 403, 404 through a specified application (for example, an education solution) and exchange data therewith. In one embodiment, when there is a transmission request of a content related to another application (for example, an application different from the application (for example, the education solution)) in the first electronic device 405, the first electronic device may transmit the content related to another application using connection information which is used in the application (for example, the education solution).

In one embodiment, when there is a transmission request of a content related to another application (for example, an application different from the specified application (for example, the education solution)) in the first electronic device 405, the first electronic device may transmit the content through the application (for example, the education solution). For example, when there is a transmission request of a content related to another application, another application may acquire connection information on the other part device to transmit the content from the application (for example, the education solution). When the connection information is acquired, another application may transmit the content to the other part device through the application.

For example, the connection information may include a user ID, a phone number, an address, a name, an IP address, a MAC address, an SSID, a node address, etc.

In one embodiment, the first electronic device 405 may be an electronic device which is used by an educator, and the second electronic device may be an electronic device which is used by an educatee 401, 402, 403, 404. Hereinafter, additional information regarding one embodiment in which the first electronic device 405 used by the educator and the second electronic device 401, 402, 403, 404 used by the educatee are connected with one another through a network will be provided. In one embodiment, the educator using the first electronic device 405 may open a class (for example, a virtual electronic class which is accessible through a network) to deliver education-related information to a plurality of educatees using the second electronic device 401, 402, 403, 404. For example, the educator using the first electronic device 405 may open the class to teach the plurality of pre-registered educatees using the electronic device 401, 402, 403, 404.

In one embodiment, when the class is opened, the first electronic device 405 may deliver class opening information to the plurality of second electronic devices 401, 402, 403, 404 connected thereto through the network. For example, when the educator using the first electronic device 405 wishes to open history and mathematics classes, the first electronic device 405 may deliver the class opening information indicating that the history class and the mathematics class are opened to the plurality of second electronic devices 401, 402, 403, 404 located within the same network.

In one embodiment, when the class opening information is delivered, the plurality of second electronic devices 401, 402, 403, 404, which have received the class opening information from the first electronic device 405, may request users to select at least one class based on class information. For example, at least one second electronic device 401 from among the second electronic devices 401, 402, 403, 404 may receive an input of selection of at least one of the one or more opened classes from the educate using the at least one second electronic device 401.

In one embodiment, the second electronic device 401, 402, 403, 404 which has received the input of selection of one of the opened classes may deliver data including an intention of attending or at least one piece of student information to the first electronic device 405 which is used by the educator. For example, each of the second electronic devices 401, 402, 403, 404 which has received selection of one of the opened classes may deliver the data including the intention of attending the class, and at least one of an identification (ID) or an Internet Protocol (IP) address of each of the edcuatees using the second electronic devices 401, 402, 403, 404 to the first electronic device.

In one embodiment, the first electronic device 405 may identify the information of the educatee and then determine whether the educatee is an educatee pre-registered at the class. For example, the first electronic device 405 may receive the ID or IP address of the student who is the educatee from each of the second electronic devices 401, 402, 403, 404 and determine whether the educatee is the educatee pre-registered at the class.

For example, when the first electronic device 405 determines that the educatee using each of the second electronic devices 401, 402, 403, 404 is the pre-registered educatee, the first electronic device may deliver information indicating that the educatee is allowed to attend the opened class to each of the second electronic devices 401, 402, 403, 404.

Based on the above-described operations, the first electronic device 405 and the second electronic device 401, 402, 403, 404 can provide an interactive class through the specified education solution. For example, the first electronic device 405 and the plurality of second electronic devices 401, 402, 403, 404 can share data, video, etc. related to the class with one another using various functions provided by the education solution. For example, the above-described education solution may provide a file sharing function, a screen sharing function, a group activity function, a control function of controlling the second electronic device 401, 402, 403, 404, a function of providing state information of the second electronic device, a function of providing image information of a user of the second electronic device, a function of providing personal information of the user of the second electronic device, etc.

According to various embodiments, the first electronic device 405 and the second electronic device 401, 402, 403, 404 may provide a plurality of applications which may be used by interworking with the education solution. For example, as shown in FIG. 4, the first electronic device 405 and the second electronic device 401, 402, 403, 404 may include at least one application which interworks with the education solution, such as first to third applications. Hereinafter, additional information regarding an example of using the plurality of applications interworking with the education solution when the class proceeds using the education solution, in the state in which the first electronic device 405 and the plurality of second electronic devices 401, 402, 403, 404 are connected to the network in the above-described method, will be provided.

In one embodiment, the first electronic device 405 may execute one of the one or more applications installed in the first electronic device 405 and the plurality of second electronic devices 401, 402, 403, 404 in relation to the operation of the education solution. The one or more applications may be applications which are installed in the first electronic device 405 or the plurality of second electronic devices 401, 402, 403, 404, or may be applications which are installed in a server and executed through the first electronic device 405 or the plurality of second electronic devices 401, 402, 403, 404. In one embodiment described below, additional information regarding a case in which the first application provided by the first electronic device 405 and the second electronic devices 401, 402, 403, 404 is an application supporting to allow users to easily create contents regarding educational materials will be provided.

In the above-described example, the first electronic device 405 may receive an input of a command to execute the first application from among the plurality of applications installed in the first electronic device 405 from the educator. For example, the first electronic device 405 may receive the command after selection of at least one of a plurality of files created by the educator is inputted. When the input of the selection is received, the first electronic device 405 may determine at least one second electronic device from among the second electronic devices 401, 402, 403, 404 to execute the selected application from among the plurality of second electronic devices 401, 402, 403, 404. For example, the first electronic device 405 may control to execute the first application in all of the second electronic devices 401, 402, 403, 404 connected to the network, or may control to execute the first application in some of the second electronic devices 401, 402, 403, 404. In one embodiment, the first electronic device 405 may identify at least one ID from among IDs assigned to the users of the at least one second electronic device 401, 402, 403, 404 through the selected first application. For example, the first electronic device 405 may search the same ID as at least one ID received from the first application from among at least one stored IDs, and may identify at least one second electronic device using the searched ID from among the at least one second electronic device.

For example, the first electronic device 405 may receive, from the user (for example, the educator), an input of selection to execute the first application in three second electronic devices 401, 402, 403 from among the second electronic devices 401, 402, 403, 404 connected through the network. In the above-described example, the first electronic device 405 may receive the ID of at least one educatee using the three second electronic devices 401, 402, 403 through the first application. In addition, for example, the first electronic device 405 may receive a content related to the first application to allow the first application to be executed in the three second electronic devices 401, 402, 403. Accordingly, the first electronic device 405 may identify the ID of a pre-registered educatee and identify the three second electronic devices 401, 402, and 403 as second electronic devices to execute the first application in association with the first electronic device 405 (for example, simultaneously).

In one embodiment, the first electronic device 405 may transmit a content related to the selected first application to the identified second electronic devices 401, 402, and 403. For example, the second electronic devices 401, 402, and 403 which receive the content related to the first application from the first electronic device 405 may search the first application from among the plurality of applications installed in the second electronic devices 401, 402, 403. The second electronic devices 401, 402, 403 may execute the searched first application and provide (for example, display) using the first application.

In the above-described embodiment, the educator who is the user of the first electronic device opens the class first. However, an embodiment in which information stored in the education solution is used before the educator opens the class is possible. For example, a case in which ten second electronic devices are set to be used by educatees who can attend a class using the first electronic device of the educator and the education solution will be explained.

In one embodiment, the educator who is the user of the first electronic device may set a second electronic device to share the class from among the ten second electronic devices connectable to the education solution in advance. For example, the educator who is the user of the first electronic device may set at least one second electronic device to proceed with an extra class from among the ten second electronic devices. For example, the first electronic device may receive selection of at least one second electronic device to proceed with the class using the education solution from the educator who is the user of the first electronic device before the first electronic device and the ten second electronic devices are connected to the education solution. Accordingly, the first electronic device and the at least one second electronic device which is selected through the first electronic device may be connected with each other through the education solution. In addition, when receiving a content related to a specific application from the second electronic device, the first electronic device may be provided with state information, image information, personal information, etc. of the second electronic device which has transmitted the corresponding content. For example, a case in which the first electronic device connected to the network along with the ten second electronic devices receives a content to execute a specific application from one of the second electronic devices will be explained.

In the above-described example, from the second electronic device which has transmitted a content to execute a specific application, the first electronic device may receive the corresponding content and simultaneously may receive a photo, personal information, etc. of the educatee who is the user of the second electronic device which has transmitted the corresponding content. Thereafter, the first electronic device may search an application to execute the received content, and then execute the searched application and simultaneously display the photo and the personal information of the educatee on a display module. Accordingly, the educator who is the user of the first electronic device may exactly recognize the educatee based on the image and the personal information of the educatee, and refer to this for the class.

In one embodiment, the second electronic devices 401, 402, 403, 404 may exchange information with one another through the network. For example, when the education solution is operated, the second electronic devices 401, 402, 403, 404 may exchange information with one another through the first electronic device 405. For example, when the education solution is operated, the second electronic devices 401, 402, 403, 404 may exchange information with one another through direct connection without passing through the first electronic device 405. In one embodiment, information exchanged among the second electronic devices 401, 402, 403, 404 may be contents related to various applications interworking with the education solution.

In one embodiment, the operation of exchanging information among the second electronic devices 401, 402, 403, 404 may be performed based on connection information of the education solution. For example, when at least one second electronic device (for example, 401) transmits a content to at least one other second electronic device (for example, 402), the at least one second electronic device (for example, 401) may determine whether an application related to the corresponding content interworks with the education solution. When it is determined that the application related to the corresponding content interworks with the education solution, the at least one second electronic device (for example, 401) may acquire connection information from the education solution. The connection information may include at least one of a user ID, a name, an address, a phone number, an email address, an IP or MAC address. The connection information is described as being used when information is transceived among the second electronic devices 401, 402, 403, 404, but is not limited to this. The connection information may be used when information is transceived between the first electronic device 405 and the second electronic device 401, 402, 403, 404.

For example, the at least one second electronic device (for example, 401) may determine whether the connection information corresponds to at least one other electronic device (for example, 402) to transmit the content. When at least one piece of information of the connection information is determined to correspond to the at least one other second electronic device (for example, 402) to transmit the content, the at least one second electronic device (for example, 401) may transmit the content through the education solution. For example, the application related to the content transmits the content to the education solution, and the education solution may transmit the received content to at least one other second electronic device (for example, 402).

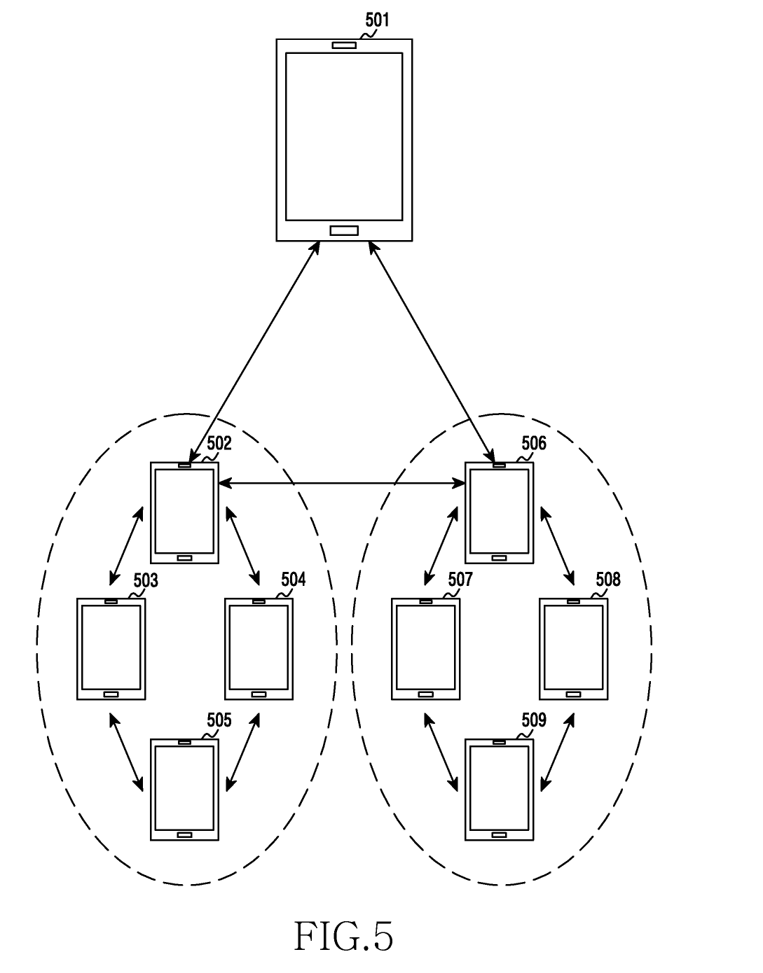

FIG. 5 illustrates a case in which various functions are set by a group activity according to one embodiment of the present disclosure. As shown in FIG. 5, for example, a first electronic device 501 may be an electronic device which is used by an educator, and second electronic devices 502, 503, 504, 505, 506, 507, 508, 509 may be electronic devices which are used by educatees. In an embodiment described below, in the state in which the first electronic device 501 and the second electronic devices 502, 503, 504, 505, 506, 507, 508, 509 are connected to a network, additional information regarding interacting using a specified application (for example, an education solution) will be provided. In addition, additional information regarding a case in which the second electronic devices 502, 503, 504, 505, 506, 507, 508, 509 are set as being divided into two groups, a first group 502, 503, 504, 505 and a second group 506, 507, 508, 509, and performing a group activity will be provided. In addition, additional information regarding a case in which the second electronic device 502 of the first group 502, 503, 504, 505 is set as a master electronic device, and the second electronic device 506 of the second group 506, 507, 508, 509 is set as a master electronic device will be provided.

In one embodiment, when the first electronic device 501 wishes to transmit materials related to a class using a specific application from among a plurality of applications interworking with the education solution, the first electronic device 501 may transmit a content related to the specific application to the master electronic devices 502 and 506 of the groups. For example, when the first electronic device 501 wishes to transmit a content related to a selected application, and identifies that a group activity is set, the first electronic device 501 may transmit the content related to the application selected by the educator to the master electronic devices 502 and 506 of the groups. In one embodiment, the master electronic devices 502 and 506 of the groups may transmit materials regarding the class using a specific application from among a plurality of applications interworking with the education solution. For example, when the master electronic devices 502 and 506 of the groups identify that the group activity is set, the master electronic devices 502 and 506 may transmit a content to execute a specific application to the first electronic device 501.

For example, each of the master electronic devices 502 and 506 may search the application related to the content received from the first electronic device 501. When the application related to the received content is installed in the master electronic devices 502 and 506, the master electronic devices 502 and 506 may execute the corresponding application to provide the received content to the users. In one embodiment, when the application related to the received content is not installed in the master electronic devices 502 and 506, the master electronic devices 502 and 506 may receive the corresponding application from a server, the first electronic device 501, or another electronic device, and install the corresponding application. When the corresponding application is installed, the master electronic devices 502 and 506 may provide the received content to the users.

In one embodiment, the master electronic devices 502 and 506 of the groups may exchange materials related to the class using a specific application from among the plurality of applications interworking with the education solution. For example, when the master electronic device 502 of the first group wishes to transmit the content related to the application to the mater electronic device 506 of the second group, the master electronic device 502 of the first group may identify setting on the group activity and setting on a master function. Accordingly, the master electronic device 502 may transmit the content related to the application to the master electronic device 506 of the second group.

In one embodiment, the master electronic device 506 of the second group may search the application related to the content received from the master electronic device 502 of the first group from among the plurality of applications interworking with the education solution. Accordingly, the master electronic device 506 may execute the searched application and provide (for example, display) the received content.

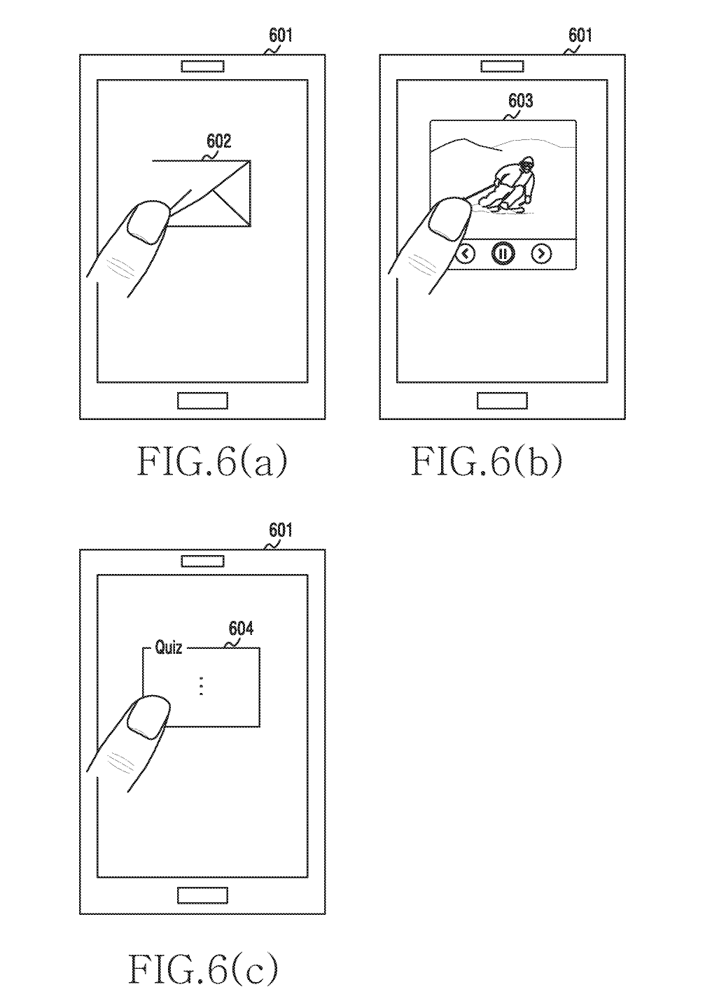

FIGS. 6(a), 6(b) and 6(c) are views showing one embodiment regarding applications interworking with an education solution according to one embodiment of the present disclosure. For example, applications 601, 602, 603 interworking with an education solution may be selected in a first electronic device 601 which is used by an educator and a second electronic device (not shown) which is used by an educatee, and may be executed both in the first electronic device 601 and the second electronic device (not shown) or may be executed only in the other part device. Hereinafter, a case in which the first electronic device 601 which is used by the educator receives an input of a command to execute an application interworking with the education solution from the educator will be explained for convenience of explanation. For example, as shown in views of FIGS. 6(a), 6(b) and 6(c), a case in which a first application installed in the first electronic device 601 and the second electronic device (not shown) is an application 602 for supporting to allow users to easily create contents related to educational materials, a video 603 related to an education, and a quiz 604 regarding a class will be explained.

In the above-described example, the first electronic device 601 may identify at least one ID from among IDs assigned to the users of the at least one second electronic device (not shown) from the selected first applications 602, 603, 604. Additionally or alternatively, the first electronic device 601 may determine whether the selected first applications 602, 603, 604 are received or not. For example, the first electronic device 601 may search the same ID as at least one ID received from the first applications 602, 603, 604 from among at least one stored ID, and identify at least one second electronic device 602 which uses the searched ID from among the at least one second electronic device (not shown).

For example, the first electronic device 601 may transmit contents related to the selected first applications 602, 603, 604 to the second electronic device using the network. For example, the second electronic device (not shown) which has received the contents related to the first applications 602, 603, 604 from the first electronic device 601 may search the first applications 602, 603, 604 from among the plurality of applications installed in the second electronic device (not shown). Accordingly, the second electronic device (not shown) may execute the searched first applications 602, 603, 604 and present the educational materials, the video related to the education, and the quiz regarding the class which are received from the first electronic device 601.

In a first electronic device, a processor may establish communication with at least one electronic device associated with a first application and located outside the electronic device, and identify at least one second electronic device to execute at least one second application associated with the first application from among the at least one electronic device based on the first application. A communication module may transmit a content related to the at least one second application to the at least one second electronic device.

The processor may be a device which is set to acquire connection information related to the at least one second electronic device from the first application.

The processor may be a device which executes the first application, and the communication module may be a device which is set to transmit the content to the at least one second electronic device using the first application.

The communication module may be a device which is set to receive, from the second application, at least one ID from among IDs assigned to users of the at least one second electronic device, and the content related to the second application. The processor may be a device which is set to search a same ID as the at least one received ID from among at least one stored ID, and identify at least one second electronic device which uses the searched ID from among the at least one second electronic device.

The processor may be a device which is set to identify that a group activity is set. The communication module may be a device which is set to transmit the content related to the second application to respective master electronic devices of a plurality of groups using the established communication.

The communication module may be a device which is set to receive a content to execute a specific application from the at least one second electronic device using the established communication. The processor may be a device which is set to search the specific application from among the at least one second application associated with the first application, and execute the searched specific application and reproduce the received content.

The communication module may be a device which is set to, when it is determined that a group activity is set, receive a content to execute a specific application from respective master electronic devices of a plurality of groups using the established communication. The processor may be a device which is set to search the specific application from among the at least one application, and execute the searched specific application and reproduce the received content.

In a second electronic device, a communication module may be a device which receives, from a first electronic device, a content to execute one application from among at least one application associated with communication established with the first electronic device using the established communication. A processor may be a device which is set to search an application to execute the received content from among the at least one application, and execute the searched application and reproduce the received content.

A display module may be a device which is set to receive selection of one of the at least one application, and the communication module may be a device which is set to transmit the content related to the selected application to the first electronic device using the established communication.

The processor may be a device which identifies that a group activity is set and a master function is assigned, and the communication module may be a device which is set to transmit the content related to the selected application to other master electronic devices of a plurality of groups using the established communication.

The communication module may be a device which is set to receive a content to execute a specific application from other master electronic devices of the plurality of groups using the established communication. The processor may be a device which is set to identify that the group activity is set and the master function is assigned, and search the specific application from among the at least one application, execute the searched specific application, and reproduce the received content.

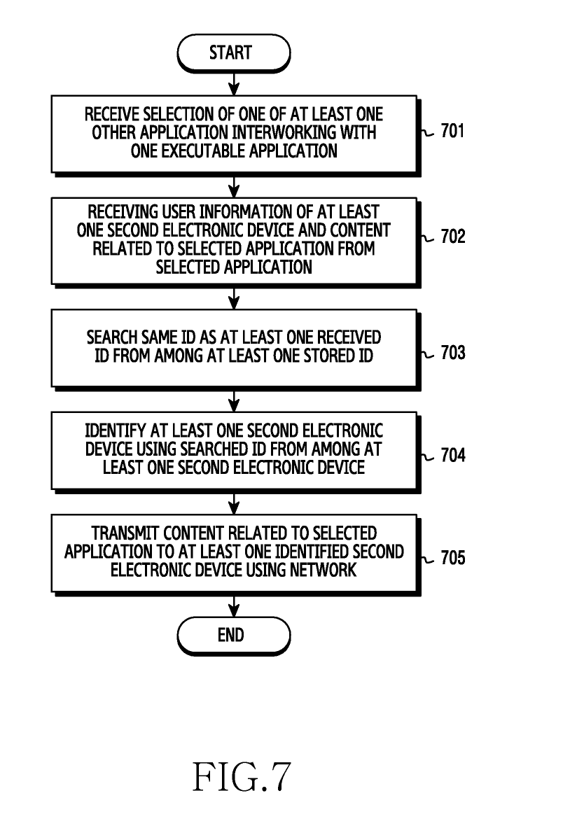

FIG. 7 is a flowchart showing an operation of a first electronic device according to one embodiment of the present disclosure. For example, in operation 701, the first electronic device may receive selection of one application from among at least one other application interworking with one application (for example, a solution) executable in the first electronic device. In operation 702, the first electronic device may receive user information of at least one second electronic device (for example, at least one ID from among IDs assigned to users, a phone number, group information, a device state, etc.), and a content related to the selected application from the selected application. For example, when the first electronic device wishes to transmit an application or a video file which can reproduce a video from an educator, who is the user of the first electronic device, to an electronic device of an educatee who uses an ID of “1234,” the first electronic device may receive an input of the video file to be executed in the electronic device of the educatee and the ID of “1234.”

In operation 703, the first electronic device may search the same ID as the at least one received ID from among at least one stored ID. For example, the first electronic device may store of IDs of students who are educatees to attend a class, and may search the same ID as the received ID_from among the IDs of the plurality of students. For example, information related to the user of the second electronic device may be searched through the installed solution. In the above-described example, the first electronic device may search the ID of “1234” from among the plurality of IDs of the students stored in the first electronic device.

In operation 704, the first electronic device may identify at least one second electronic device which uses the search ID from among the at least one second electronic device. In the above-described example, the first electronic device may identify the second electronic device which uses the ID of “1234” from among the plurality of second electronic devices.

In operation 705, the first electronic device may transmit a content related to the selected application to the at least one identified second electronic device using a network. For example, the content related to the selected application may be transmitted to the at least one identified second electronic device through an application other than the selected application. In the above-described example, the first electronic device may transmit a video content regarding an education to the second electronic device which uses the ID of “1234.”

In the present embodiment, the first electronic device transmits the content related to the application to the at least one second electronic device using the connected network. However, the first electronic device may receive a content related to an application from the at least one second electronic device using the connected network.

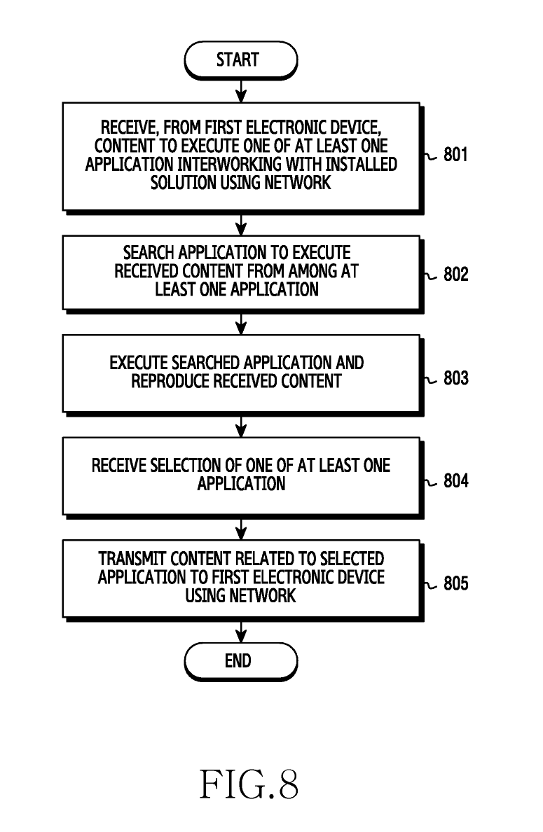

FIG. 8 is a flowchart showing an operation sequence of a second electronic device which is used by an educatee according to one embodiment of the present disclosure. For example, in operation 801, the second electronic device may receive a content to execute one application from among at least one application interworking with an installed solution from a first electronic device using a network.

In operation 802, the second electronic device may search the application to execute the received content from among the at least one application. For example, when the content received by the second electronic device from the first electronic device is a content related to a first application, the second electronic device may search the first application from among a plurality of installed applications.

In operation 803, the second electronic device may execute the searched application and reproduce the received content. In the above-described example, the second electronic device may receive the content related to the first application received from the first electronic device, execute the first application installed in the second electronic device, and reproduce the related content.

In operation 804, the second electronic device may receive selection of one application from among the at least one application. For example, when first to tenth applications are set in the first electronic device and the second electronic device, the second electronic device may receive selection of the first application from among the first to tenth applications.

In operation 805, the second electronic device may transmit the content related to the selected application to the first electronic device using the network. In the above-described example, the second electronic device may transmit the content related to the first application which is selected by the educatee who is the user of the second electronic device using the connected network.

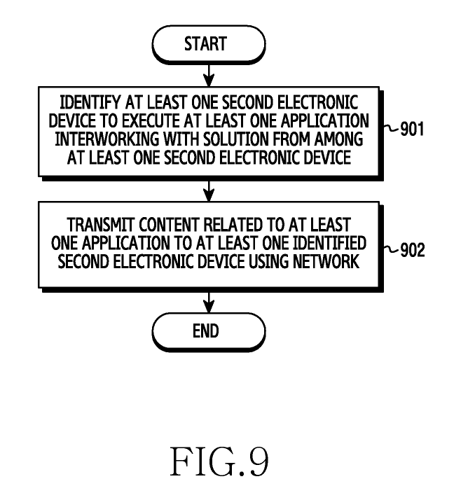

FIG. 9 illustrates an operation of a first electronic device which is used by an educator according to one embodiment of the present disclosure. In operation 901, the first electronic device may identify at least one second electronic device to execute at least one application interworking with a solution from among at least one second electronic device. For example, the first electronic device may receive at least one ID from among IDs assigned to users of the at least one second electronic device and a content related to a selected application from the selected application. For example, the first electronic device may search the same ID as the at least one received ID from among at least one stored ID, and identify at least one second electronic device which uses the searched ID from among the at least one second electronic device.

In operation 902, the first electronic device may transmit a content related to the at least one application to the at least one second electronic device using a network. For example, the first electronic device may transmit the content related to the selected application to the second electronic device, such that the application selected by the user is reproduced in the second electronic device.

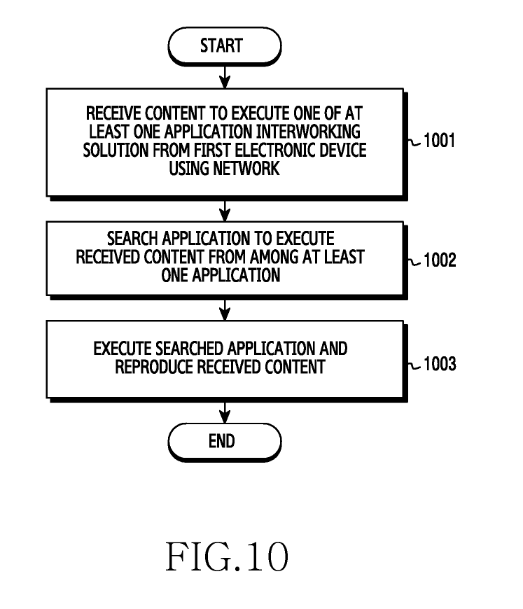

FIG. 10 is a flowchart showing an operation of a second electronic device which is used by an educatee according to one embodiment of the present disclosure. For example, in operation 1001, the second electronic device may receive a content to execute one application from among at least one application interworking with a solution from a first electronic device using a network.

In operation 1002, the second electronic device may search an application to execute the received content from the at least one application. For example, when the content received by the second electronic device from the first electronic device is a content related to a first application, the second electronic device may search the first application from among a plurality of installed applications.

In operation 1003, the second electronic device may execute the searched application and reproduce the received content. In the above-described example, the second electronic device may receive the content related to the first application received from the first electronic device, execute the first application installed in the second electronic device, and reproduce the related content.

In various embodiments, the series of processes explained in FIGS. 7 to 10 may be executed in reverse order, simultaneously, or in parallel unlike in FIGS. 7 to 10.

A method may include: establishing, by a first electronic device, communication with at least one electronic device associated with a first application and located outside the first electronic device; identifying, by the first electronic device, at least one second electronic device to execute at least one second application associated with the first application from among the at least one electronic device based on the first application; and transmitting, by the first electronic device, a content related to the at least one second application to the at least one second electronic device.

The identifying may be identifying connection information related to the at least one second electronic device from the first application.

The connection information may include at least one of a user ID, a phone number, an address, a name, a Internet Protocol (IP) address, a Media Access Control (MAC) address, a Service Set Identifier (SSID), or a node address.

The transmitting may include executing the first application and transmitting the content to the at least one second electronic device using the first application.

The first application may be an education solution including at least one function of a file sharing function, a screen sharing function, a group activity function, a control function of controlling the second electronic device, a function of providing state information of the second electronic device, a function of providing image information of a user of the second electronic device, and a function of providing personal information of a user of the second electronic device.

The identifying may include: receiving, from the second application, at least one ID from among IDs assigned to users of the at least one second electronic device, and the content related to the second application; searching a same ID as the at least one received ID from among at least one stored ID; and identifying at least one second electronic device which uses the searched ID from among the at least one second electronic device, and the ID may include an ID which is used when the first application is used.

The transmitting may include, when a group activity is set, transmitting the content related to the second application to respective master electronic devices of a plurality of groups using the established communication.

The method may further include: receiving a content to execute a specific application from the at least one second electronic device using the established communication; searching the specific application from among the at least one second application associated with the first application; and executing the searched specific application and reproducing the received content.

The method may further include: when it is determined that a group activity is set, receiving a content to execute a specific application from respective master electronic devices of a plurality of groups using the established communication; searching the specific application from among the at least one application; and executing the searched specific application and reproducing the received content.

A method may include: receiving, by a second electronic device from a first electronic device, a content to execute one application from among at least one application associated with communication established with the first electronic device using the established communication; searching an application to execute the received content from among the at least one application; and executing the searched application and reproducing the received content.

The application may be an education solution including at least one function of a file sharing function, a screen sharing function, a group activity function, a control function of controlling the second electronic device, a function of providing state information of the second electronic device, a function of providing image information of a user of the second electronic device, and a function of providing personal information of a user of the second electronic device.

The method may further include receiving selection of one of the at least one application; and transmitting the content related to the selected application to the first electronic device using the established communication.

The transmitting may include, when it is identified that a group activity is set and a master function is assigned, transmitting the content related to the selected application to other master electronic devices of a plurality of groups using the established communication.

The method may further include: when it is identified that the group activity is set and the master function is assigned, receiving a content to execute a specific application from other master electronic devices of the plurality of groups using the established communication; searching the specific application from among the at least one application; and executing the searched specific application and reproducing the received content.

A second electronic device may include: a communication module which receives, from a first electronic device, a content to execute one application from among at least one application associated with communication established with the first electronic device using the established communication; and a processor which searches an application to execute the received content from among the at least one application, and executes the searched application and reproduces the received content.

The second electronic device may further include a user input module which receives selection of one of the at least one application, and the communication module may transmit the content related to the selected application to the first electronic device using the established communication.

The processor may identify that a group activity is set and a master function is assigned, and the communication module may transmit the content related to the selected application to other master electronic devices of a plurality of groups using the established communication.

The communication module may receive a content to execute a specific application from other master electronic devices of the plurality of groups using the established communication, and the processor may identify that the group activity is set and the master function is assigned, and search the specific application from among the at least one application, execute the searched specific application, and reproduce the received content.

According to various embodiments of the present disclosure, when an electronic device exchanges information with other electronic devices, the electronic device may acquire connection information regarding other electronic devices through applications associated with each other, so that information can be transmitted or received without establishing a separate communication link and performance of a system can be enhanced.

The above-described present disclosure can be changed to various forms or applied by a person skilled in the art, and the scope of the technical idea according to the present disclosure should be defined by the claims presented below.

What is claimed is:

1. A method comprising:
establishing, by a first electronic device, communication with at least one electronic device associated with a first application and located outside the first electronic device;
identifying, by the first electronic device, at least one second electronic device to execute at least one second application associated with the first application from among the at least one electronic device based on the first application; and
transmitting, by the first electronic device, a content related to the at least one second application to the at least one second electronic device.

2. The method of claim 1, wherein the identifying comprises identifying connection information comprising at least one of a user ID, a phone number, an address, a name, a Internet Protocol (IP) address, a Media Access Control (MAC) address, a Service Set Identifier (SSID), or a node address.

3. The method of claim 1, wherein the transmitting comprises executing the first application and transmitting the content to the at least one second electronic device using the first application.

4. The method of claim 1, wherein the identifying comprises:
receiving, from the second application, at least one ID from among IDs assigned to users of the at least one second electronic device, and the content related to the second application;
searching a same ID as the at least one received ID from among at least one stored ID; and
identifying at least one second electronic device which uses the searched ID from among the at least one second electronic device, and
wherein the ID comprises an ID which is used when the first application is used.

5. The method of claim 1, wherein the transmitting comprises, when a group activity is set, transmitting the content related to the second application to respective master electronic devices of a plurality of groups using the established communication.

6. The method of claim 1, further comprising:
receiving a content to execute a specific application from the at least one second electronic device using the established communication;
searching the specific application from among the at least one second application associated with the first application; and
executing the searched specific application and reproducing the received content.

7. The method of claim 1, further comprising:
when it is determined that a group activity is set, receiving a content to execute a specific application from respective master electronic devices of a plurality of groups using the established communication;
searching the specific application from among the at least one application; and
executing the searched specific application and reproducing the received content.

8. A first electronic device comprising:
a processor configured to establish communication with at least one electronic device associated with a first application and located outside the first electronic device, and identify at least one second electronic device to execute at least one second application associated with the first application from among the at least one electronic device based on the first application; and
a communication module configured to transmit a content related to the at least one second application to the at least one second electronic device.

9. The first electronic device of claim 8, wherein the processor is configured to acquire at least one of a user ID, a phone number, an address, a name, an IP address, a MAC address, an SSID, or a node address as connection information related to the at least one second electronic device.

10. The first electronic device of claim 8, wherein the first application is configured to comprise an education solution comprising at least one function of a file sharing function, a screen sharing function, a group activity function, a control function of controlling the second electronic device, a function of providing state information of the second electronic device, a function of providing image information of a user of the second electronic device, and a function of providing personal information of a user of the second electronic device.

11. The first electronic device of claim 8, wherein the communication module is configured to: receive, from the second application, at least one ID from among IDs assigned to users of the at least one second electronic device, and the content related to the second application; search a same ID as the at least one received ID from among at least one stored ID; and identify at least one second electronic device which uses the searched ID from among the at least one second electronic device, and
wherein the ID comprises an ID which is used when the first application is used.

12. The first electronic device of claim 8, wherein the processor is configured to identify that a group activity is set, and the communication module is configured to transmit the content related to the second application to respective master electronic devices of a plurality of groups using the established communication.

13. The first electronic device of claim 8, wherein the communication module is configured to receive a content to execute a specific application from the at least one second electronic device using the established communication, and
wherein the processor is configured to search the specific application from among the at least one second application associated with the first application, and execute the searched specific application and reproduce the received content.

14. The first electronic device of claim 8, wherein, when it is determined that a group activity is set, the communication module is configured to receive a content to execute a specific application from respective master electronic devices of a plurality of groups using the established communication, and
wherein the processor is configured to search the specific application from among the at least one application, and execute the searched specific application and reproduce the received content.
